(19) United States
(12) Patent Application Publication
(10) Pub. No.: US 2013/0170413 A1
(43) Pub. Date: Jul. 4, 2013

(54) METHODS AND SYSTEMS FOR POWER SAVING CONTROLS IN MOBILE BROADCAST RECEIVER

(71) Applicants: Felix Chow, Hong Kong (HK); Wing Ki Yeung, Hong Kong (HK)

(72) Inventors: Felix Chow, Hong Kong (HK); Wing Ki Yeung, Hong Kong (HK)

(73) Assignee: Hong Kong Applied Science and Technology Research Institute Company Limited, Hong Kong (HK)

(21) Appl. No.: 13/338,258

(22) Filed: Dec. 28, 2011

(51) Int. Cl. H04W 52/02; H04J 3/00

(52) U.S. Cl. 370/311

(57) ABSTRACT

In a broadcast receiver for receiving a digital broadcast signal that carries time division multiplexed content programs or channels configured for power saving modes, the tuner, the ADC, the sub-modules within demodulator core, and the decoder are partitioned into multiple power domains forming a signal data processing pipeline with stages that are corresponding to the power domains and according to the boundaries of the data processing steps. During burst timeslot, only the power domain that is processing the signal data is turned on. Once the processing is completed the power domain is turned off. The power domains are turned off during non-burst timeslot. The ADCs and the first power domain are turned on one timeslot prior the beginning of the next burst timeslot. Therefore, the receiver can simply disregard any residual data in the processing pipeline from the last burst cycle and data flushing is not necessary.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The presently claimed invention relates generally to electric power saving schemes of electronic circuitries. Specifically, the presently claimed invention relates to the methods and devices for electric power saving controls in communication demodulator integrated circuitries.

### BACKGROUND

Power saving is of particular interest to certain electronic circuitry designs. Especially where the application is for a portable device in which its electronic components draw electric power from a battery. One power saving approach is to cut off power supply to the components when they are not in used. A mobile digital broadcasting receiver device in a broadcasting network typically comprises modules such as tuner, demodulator, and decoder. When the receiver device receives a broadcast signal, the signal is processed in stages by the tuner, demodulator, and decoder. Therefore, different modules can be turned on and off depending on the signal processing stage to avoid unnecessary power consumption by the idling modules.

A commercial digital broadcast signal can carry multiple content programs or channels in a time-division multiplexed manner, such as one that is implementing the China Mobile Multimedia Broadcasting (CMMB) standard. The timeslot in which the desired content program or channel is being transmitted is called the “burst”. Various modules in the receiver device can be turned off during those time periods other than the burst periods. U.S. Patent Application Publication No. 2009/0153746 discloses such a system in which the receiver is only turned on during burst periods. However, this system provides only a high level power down controls according to the timeslot boundaries of the content channel time division multiplexing, and further reduction in power consumption during burst periods is not possible.

Error correction schemes are regularly deployed in digital communication. Particularly in the case of mobile reception, which is subjected to environmental interferences, enhanced error detection and correction using various encoding and decoding techniques are used in the design of the communication protocol. One example is the Digital Video Broadcasting over Handheld (DVB-H). One approach for power conservation for a mobile receiver device receiving a broadcast signal carrying both the service data and error parity data is to switch the receiver modules to power saving mode once error correction is completed. In U.S. Pat. No. 7,865,218, a broadcasting receiver device is disclosed using an enhanced error correction unit to perform error correction twice to improve the correction capability. It allows the device to switch to power saving mode earlier during burst periods once the data errors are corrected. However, the enhanced error correction unit increases the complexity and size of the circuitry, hence causing higher power consumption and limiting the amount of power saved.

If a broadcast receiver is turned off or made inactive during a burst period, it must be awaken before the next burst period starts. The receiver should, in fact, be powered on at least for a short period of time before the burst period begins to allow it to re-synchronize with the broadcast signal. U.S. Pat. No. 7,729,462 discloses a fast re-synchronization technique which allows late power-on of the receiver hence achieving power saving through longer time period of power saving mode. However, this technique provides also only a high level power down controls according to the timeslot boundaries of the time division multiplexing. Furthermore, the disclosed fast re-synchronization technique requires data flushing in the processing pipeline resulting in additional complexity in the circuitry.

### SUMMARY

It is an objective of the presently claimed invention to provide a method and a system for mobile broadcast receiver power saving controls at a sub-module level such that further reduction in power consumption can be achieved during broadcasting burst periods. It is a further objective of the presently claimed invention to provide such method and system without introducing excessive complexity to the design of the circuitry of the receiver. It is still a further objective of the presently claimed invention that the method and system includes a re-synchronization process, which does not require data flushing in the processing pipeline.

In accordance to various embodiments of the presently claimed invention, the tuner, the analog-digital converters (ADCs), the sub-modules within demodulator core, and the decoder are partitioned into multiple power domains forming a signal data processing pipeline with stages that are corresponding to the power domains and according to the boundaries of the data processing steps. Each power domain further comprises isolation cell and retention cell circuitries for retaining the signal data for processing in the power domain during the respective active processing stage. Only the power domain that is processing the signal data is turned on or made active. Once the processing is completed the power domain is turned off. A power control unit provides the control signal for the power domains according to a power saving control logic with input from a synchronizer FFT sub-module that is used to synchronize the data processing pipeline with the time division multiplexing in the broadcast signal. Therefore, the mobile broadcasting receiver is dynamically powered down at a sub-module level.

In accordance to various embodiments of the presently claimed invention, the first power domain in the data processing pipeline is turned on at least one timeslot prior to the burst timeslot. Therefore, the receiver can simply disregard any residual data in the processing pipeline from the last burst cycle and data flushing is not necessary.

### BRIEF DESCRIPTION OF THE DRAWINGS

Embodiments of the invention are described in more detail hereinafter with reference to the drawings, in which:

FIG. 1 illustrates schematically the time division multiplexing structure of a broadcast signal under the China Mobile Multimedia Broadcasting (CMMB) standard;

FIG. 2 shows a schematic diagram of the tuner, ADC, and demodulator modules of an exemplary broadcast receiver;

FIG. 3 shows a schematic diagram of the sub-modules in the signal data processing pipeline and the power domain partition in accordance to an embodiment of the presently claimed invention;

FIG. 4 shows a simplified timeline of the power-on time of the power domains in accordance to an embodiment of the presently claimed invention;

FIG. 5 illustrates the effect of residual data in the signal data processing pipeline from the non-burst or inactive timeslot of the last burst cycle; and

FIG. 6 illustrates the effect of concatenation of the residual data with data entering the signal data processing pipeline in the non-burst or inactive timeslot immediately prior to the next burst or active timeslot.

### DETAILED DESCRIPTION

In the following description, methods and systems for power saving controls in mobile broadcast receiver are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

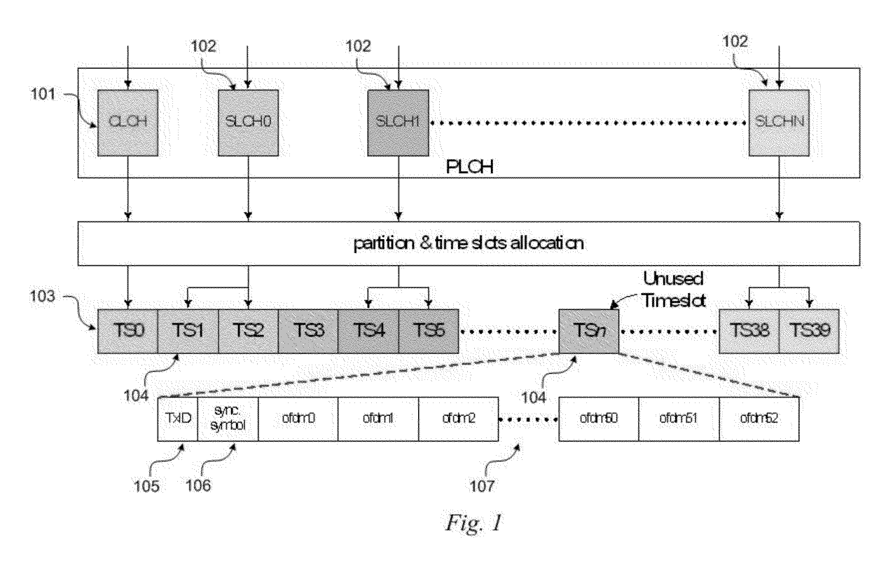

The preferred embodiment of the presently claimed invention applies to a digital broadcast receiver for receiving digital broadcast signal that carries multiple content programs or channels in a time-division multiplexed manner, such as one that is implementing the China Mobile Multimedia Broadcasting (CMMB) standard. Referring to FIG. 1. The CMMB standard features a multi-carrier broadcast signal with Cyclic Prefix Orthogonal Frequency Division Multiplexing (CP-OFDM). The CMMB standard has a well-defined channelization structure, in which one PHY link is divided into Frames of one second duration. Each Frame is partitioned into forty timeslots of twenty-five second duration each. A timeslot is the minimum unit for data carrying resource allocation. Within a Frame, the first timeslot 103 is allocated to control logic channel (CLCH) 101 whereas the other thirty-nine timeslots 104 are allocated to service logic channels (SLCH) 102. One SLCH can occupy multiple timeslot in a Frame as required by the system throughput of the broadcasting service. Each timeslot is composed of one signaling field and one data field. The signaling field comprises a TxID OFDM symbol 105 and a synchronization symbol 106. The data field comprises fifty-three data OFDM symbols 107.

A broadcast receiver in a CMMB network always receives and processes at least the CLCH, thus the first timeslot within a Frame is always a burst (active) timeslot. In addition, the one or more timeslots carrying the user selected SLCH are also burst timeslots.

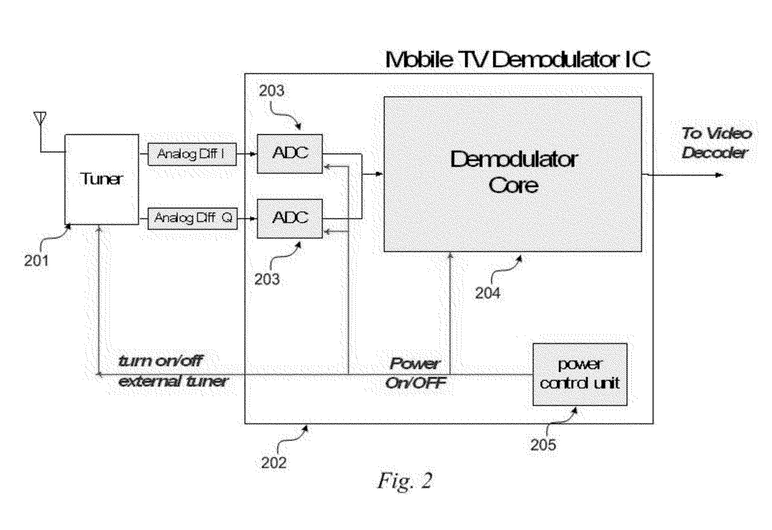

Referring to FIG. 2. A typical power control implementation in mobile broadcast receiver, such as a mobile television receiver for CMMB broadcasting system, comprises at least a tuner 201, one or more ADCs 203, a demodulator core 204, and a power control unit 205. The ADCs 203, demodulator core 204, and power control unit 205 can be implemented in a single demodulator integrated circuit (IC) 202. The power control unit 205 switches the demodulator IC 202 on and off and provides the power on/off signal to the external tuner 201 according to the timeslot boundaries of the time division multiplexing. In traditional power control designs, all modules are turned on during the burst timeslots and off during other timeslots to reduce power consumption. However, because the signal data is processed in stages by different modules, some modules would have been unused or idling for certain periods of time even during the burst timeslots. The presently claimed invention achieves further reduction in power consumption by timely turning off these unused or idling modules during burst timeslots.

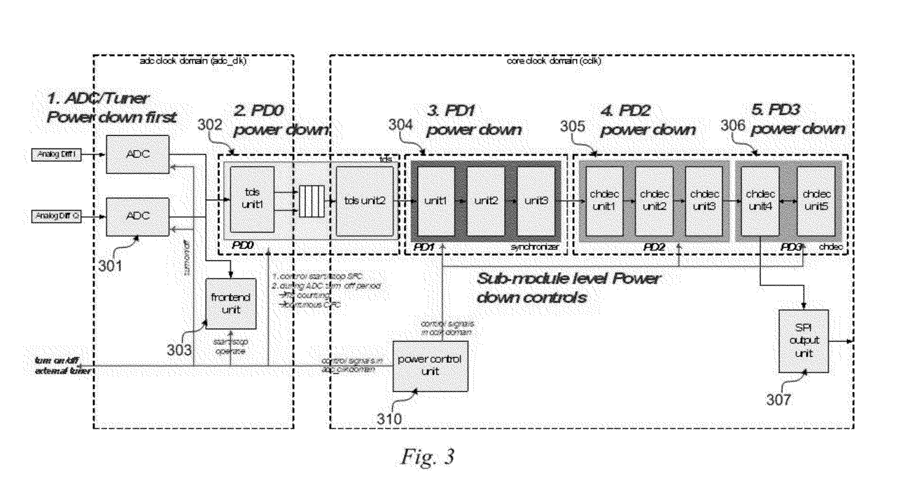

Referring to FIG. 3. In accordance to various embodiments of the presently claimed invention, the tuner, the ADCs 301, the sub-modules within the demodulator core, and the decoder are partitioned into a plurality of power domains forming a signal data processing pipeline with stages that are corresponding to the power domains and according to the boundaries of the data processing steps. The constituents of the power domains depend on the functionality of the constituents in regards to the processing of the signal data. In accordance to one embodiment, the first power domain (PD₀) 302 comprises the time domain synchronization (TDS) processing circuitry units and the frontend circuitry unit 303; the second power domain (PD₁) 304 comprises the synchronizer including the FFT sub-module; the third power domain (PD₂) 305 comprises the early-stage channel decoder (CHDEC) circuitry units; and the forth power domain (PD₃) 306 comprises the later-stage CHDEC circuitry units and the SPI output circuitry unit 307.

Still referring to FIG. 3. Each power domain further comprises isolation cell and retention cell circuitries for retaining the signal data for processing in the power domain during the respective active processing stage. When the broadcast receiver is configured to be in power saving mode, only the power domain that is processing the signal data is turned on. The power domains can also be turned on and off individually for testing and troubleshooting purposes. Once the processing is completed, the power domain is turned off. A power control unit 310 provides the control signal for the power domains according to a power saving control logic with input from a synchronizer FFT sub-module that is used to synchronize the data processing pipeline with the timeslots of time division multiplexing in the broadcast signal. The power control unit 310 also provides the control signal to the tuner and ADCs 301, which can be turned on and off independent of the other power domains. Due to the fact that ADCs in a receiver can consume up to seventy percent of the power, turning off the ADCs 301 during non-burst time periods and early during burst once the signal data is received and processed can significantly reduce the receiver's power consumption.

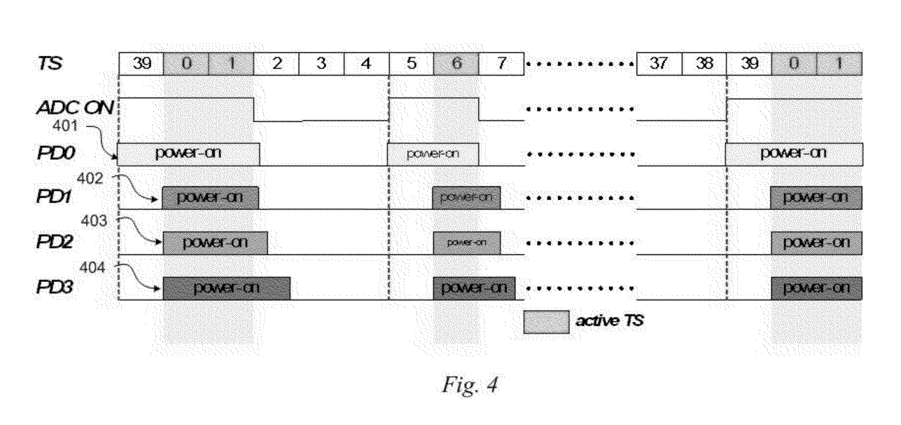

Referring to FIG. 4. To illustrate the power domain's staged power on/off cycle, assuming the burst timeslots are TS₀, TS₁, and TS₆ where TS₀, TS₁, and TS₆∈{TS₀, TS₁, . . . , TS₃₉} within a Frame under the CMMB standard. In accordance to one embodiment of the presently claimed invention, the ADCs and PD₀ are to be turned on at least one timeslot earlier than the beginning of the next burst timeslot. The precursory power-on time period allows the receiver to perform resynchronization with the broadcast signal and channel estimation. Once the signal data carried in TS₀ and TS₁ (CLCH for TS₀ and a SLCH for TS₁) is received and processed, the ADCs and PD₀, the ADCs and PD₀ are turned off at the end of TS₁. Therefore, the ADCs and PD₀ are active for a time period 401: t₀=TS_{39 (previous Frame)}+TS₀+TS₁+t_{ADC}_{_{—}}_{PD0}, where t_{ADC}_{_{—}}_{PD0} is the processing time of the signal data in ADCs and PD₀, starting from the beginning of TS_{39 (previous Frame)}. The signal data then enters PD₁. PD₁ is active for a time period 402: t₁=2 TS+t_{PD1}, where t_{PD1} is the processing time of the signal data in PD₁, starting from the beginning of TS₀. The signal data then enters PD₂. PD₂ is active for a time period 403: t₂=2TS+t_{PD2}, where t_{PD2} is the processing time of the signal data in PD₂, starting from the beginning of TS₀. Finally, the signal data then enters PD₃. PD₃ is active for a time period 404: t₃=2TS+t_{PD3}, where t_{PD3} is the processing time of the signal data in PD₃, starting from the beginning of TS₀. The power on/off cycle repeats for the next burst timeslot TS₆ again with the ADCs and PD₀ being turned on first at the beginning of TS₅.

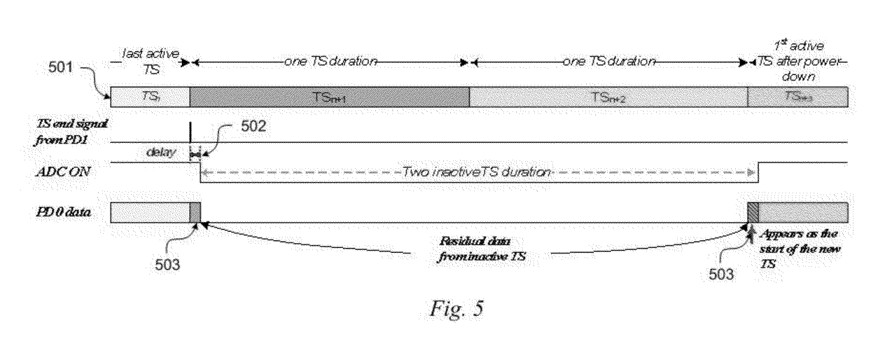

In accordance to various embodiments of the presently claimed invention, the power control unit provides the control signal for the power domains according to a power saving control logic with input from a synchronizer FFT sub-module. Because the FFT sub-module belongs to the second power domain PD₁ and because of the asynchronous nature of the data sampling process in the signal data processing pipeline, certain data would have entered the ADCs and PD₀ before the control signal is sent to turn off the data processing pipeline during the non-burst (inactive) timeslots. FIG. 5 illustrates this effect. The ADCs and PD₀ are turned off at the end of the last burst (active) timeslot TSₙ 501 plus a delay 502 to account for the processing time of the signal data in the ADCs and PD₀. As a result, data 503 from the non-burst (inactive) timeslot has already entered the ADCs and PD₀. This residual data is retained in the data processing pipeline until the next burst (active) timeslot TSₙ₊₃ 504 and will appear at the beginning of the new burst (active) timeslot.

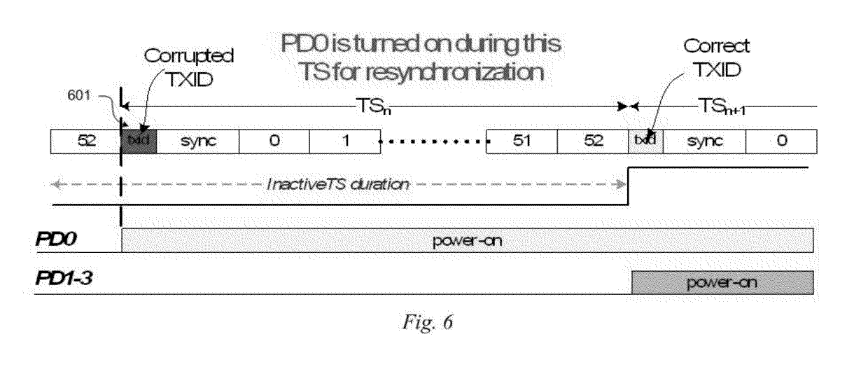

Referring to FIG. 6. Due to the aforementioned residual data effect, the first symbol 601 (TxID as in CMMB standard) in the new burst (active) timeslot is corrupted by the concatenation of the residual data. However, according to an embodiment of the presently claimed invention, since the ADCs and PD₀ are to be turned on at least one timeslot prior to the burst (active) timeslot, all the initial data that appears in the ADCs and PD₀ can be disregarded and the signal data in the burst (active) timeslot eventually arrives at the ADCs and PD₀ uncorrupted. This simplifies the data processing pipeline implementation, avoiding the need for residual data flushing and latency estimation.

In accordance to various embodiments of the presently claimed invention, the first power domain in the data processing pipeline is turned on at least one timeslot prior to the burst timeslot. Therefore, the receiver can simply ignore any residual data in the processing pipeline from the last burst cycle and data flushing is not necessary.

The embodiments disclosed herein may be implemented using general purpose or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

In some embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

What is claimed is:

1. A method for power saving control in a broadcast receiving device receiving a broadcast signal carrying time division multiplexed signal data, comprising:
partitioning a plurality of electronic modules and sub-modules in the broadcast receiver into one or more power domains forming a signal data processing pipeline with stages that are corresponding to the power domains and according to boundaries of data processing steps; and
controlling, by a power control unit, power on and off of the modules and sub-modules within each of the power domains, wherein each of the power domains individually powers on at least during active timeslots of the broadcast signal plus data processing time of the respective individual power domain and individually powers off thereafter.

2. The method of claim 1, further comprising:
controlling, by the power control unit, power on and off of one or more analog-digital converters in the broadcast receiver, wherein the analog-digital converters power on during active timeslot of the broadcast signal plus data processing time of the analog-digital converters, then power off thereafter.

3. The method of claim 1, wherein the modules and sub-modules include one or more of tuner, analog-digital converter, time domain synchronization processing circuitry unit, frontend circuitry unit, synchronizer, channel decoder circuitry unit, and SPI output circuitry unit.

4. The method of claim 1, wherein a first power domain among the one or more power domains powers on at least one timeslot prior to beginning of each active timeslot and during active timeslots of the broadcast signal plus data processing time of the first power domain, then powers off thereafter.

5. The method of claim 1, further comprising:
controlling, by the power control unit, power on and off of one or more analog-digital converters in the broadcast receiver, wherein the analog-digital converters power on at least one timeslot prior to beginning of each active timeslot and during active timeslots of the broadcast signal plus data processing time of the analog-digital converters, then power off thereafter.

6. The method of claim 4, further comprising:
prior to beginning of each active timeslot, concatenating residual data in the signal data processing pipeline with new data in the signal data processing pipeline, and disregarding the residual-new concatenated data.

7. A broadcast receiving device for receiving a broadcast signal carrying time division multiplexed signal data, comprising:
a plurality of electronic modules and sub-modules partitioned into one or more power domains forming a signal data processing pipeline with stages that are corresponding to the power domains and according to boundaries of data processing steps; and
a power control unit for controlling power on and off of the modules and sub-modules within each of the power domains, wherein each of the power domains individually powers on at least during active timeslots of the broadcast signal plus data processing time of the respective individual power domain and individually powers off thereafter.

8. The device of claim 7, further comprising:
one or more analog-digital converters;
wherein the power control unit controls power on and off of the analog-digital converters; and
wherein the analog-digital converters power on during active timeslot of the broadcast signal plus data processing time of the analog-digital converters, then power off thereafter.

9. The device of claim 7, wherein the modules and sub-modules include one or more of tuner, analog-digital converter, time domain synchronization processing circuitry unit, frontend circuitry unit, synchronizer, channel decoder circuitry unit, and SPI output circuitry unit.

10. The device of claim 7, wherein a first power domain among the one or more power domains powers on at least one timeslot prior to beginning of each active timeslot and during active timeslots of the broadcast signal plus data processing time of the first power domain, then powers off thereafter.

11. The method of claim 7, further comprising:
one or more analog-digital converters;
wherein the power control unit controls power on and off of the analog-digital converters; and
wherein the analog-digital converters power on at least one timeslot prior to beginning of each active timeslot and during active timeslots of the broadcast signal plus data processing time of the analog-digital converters, then power off thereafter.

12. The device of claim 10, wherein prior to beginning of each active timeslot, residual data in the signal data processing pipeline is concatenated with new data in the signal data processing pipeline, and the residual-new concatenated data is disregarded by the signal data processing pipeline.
